(19) United States
(12) Patent Application Publication
(10) Pub. No.: US 2007/0211999 A1
(43) Pub. Date: Sep. 13, 2007

(54) Optical Connector

(76) Inventors: Shigeru Kobayashi, Tokyo (JP); Nobuaki Ohtsu, Kanagawa (JP); Takehiro Hayashi, Kanagawa (JP)

Correspondence Address: BARLEY SNYDER, LLC, 1000 WESTLAKES DRIVE, SUITE 275, BERWYN, PA, 19312, US

(21) Appl. No.: 11/684,439

(22) Filed: Mar. 9, 2007

(30) Foreign Application Priority Data
Mar. 10, 2006 (JP) 2006-66182

(51) Int. Cl. G02B 6/32

(52) U.S. Cl. 385/79; 385/35

(57) ABSTRACT

The optical fiber connector of the present invention includes a housing having a ferrule receiving passageway and a lens receiving portion which is disposed on the front end portion of this ferrule receiving passageway. A central axis is coaxial with the central axis of the ferrule receiving passageway. A spherical lens is fastened to the lens receiving portion and a ferrule is inserted into the ferrule receiving passageway from the rear side and is incorporated with an optical fiber whose front end surface is perpendicular to the central axis. A transparent block having a refractive index that is substantially the same as the refractive indices of the lens and optical fiber is disposed between the lens and the ferrule so that this block contacts the lens, the ferrule, and the optical fiber. A refractive index matching agent having a refractive index substantially the same as the refractive indices of the lens and optical fiber is applied around the contact point between the lens and the block and around the contact surface between the ferrule and the block. The thickness of the block in the direction of beam transmission is set to be the same as the distance to the focal point from the end surface of the lens.

### CROSS-REFERENCE TO RELATED APPLICATIONS

This application claims the benefit of the filing date under 35 U.S.C. §119(a)-(d) of Japanese Patent Application No. 2006-66182, filed Mar. 10, 2006.

### FIELD OF THE INVENTION

The present invention relates to an optical connector comprising an optical element such as an optical fiber collimator.

### BACKGROUND

When high-speed large-capacity optical fiber communication systems are built, numerous optical devices are used. Such devices include devices that extract an optical signal of an arbitrary wavelength from an optical signal obtained by multiplexing a plurality of wavelengths, devices that use an optical crystal for matching the phase of the optical signal, and the like, and numerous optical fiber collimators which convert an optical signal emitted and spread from an optical fiber into parallel beams or which cause parallel beams to collect in an optical fiber.

The main function of such optical fiber collimators is to propagate parallel beams for a desired distance without attenuation. Low insertion loss and high return loss are generally desired.

In order to realize such low insertion loss and high return loss, methods are often used in which anti-reflective coatings are provided on the entire lens surface and the end surface of an optical fiber. Alternatively, the end surface of an optical fiber close to a lens is diagonally disposed in order to obtain a higher return loss such that the reflected beam is reflected to the outside from the optical fiber core.

The optical fiber collimator shown in FIG. 7 (see JP-A-2004-302453), for example, has been known as a conventional optical fiber collimator of this type in which the end surface of the optical fiber is diagonally disposed. The optical fiber collimator 101 shown in FIG. 7 comprises a partially spherical lens 102 that has beam-transmitting spherical surfaces 102a having the same radius of curvature at both ends of the cylindrical part, a tube 103 which contains an optical fiber 104 whose end surface 104a is inclined, and an eccentric sleeve 105 that has an passageway 105a for attaching the partially spherical lens 102 and tube 103. Furthermore, the central axis Z of the parallel beam emitted from the partially spherical lens 102 is within a radial range of 0.02 mm centered on the central axis B of the outer circumferential surface of the eccentric sleeve 105, and has an angle of 0.2° or less with respect to the central axis B of the outer circumferential surface of the eccentric sleeve 105.

With this optical fiber collimator 101, a high return loss can be obtained because the end surface 104a of the optical fiber 104 is inclined. Here, if the end surface 104a of the optical fiber 104 is inclined, the following problem arises: namely, a beam is emitted from the end surface 104a of the optical fiber 104 in a diagonal direction with respect to the central axis A of the partially spherical lens 102 in accordance with the law of refraction; as a result, in the parallel beam emitted from the partially spherical lens 102, an eccentricity 6 is generated between the central axis Z of this parallel beam and the central axis A of the partially spherical lens 102. When an eccentricity 6 is generated between the central axis Z of the parallel beam and the central axis A of the partially spherical lens 102, in cases where mutually facing optical fiber collimators are aligned with reference to the external diameter, a lack of alignment of the central axes Z of the parallel beams becomes a problem. However, in the case of the optical fiber collimator 101 shown in FIG. 7, because the central axis Z of the parallel beam emitted from the partially spherical lens 102 is within a radial range of 0.02 mm centered on the central axis B of the outer circumferential surface of the eccentric sleeve 105, and has an angle of 0.2° or less with respect to the central axis B of the outer circumferential surface of the eccentric sleeve 105, in cases where mutually facing optical fiber collimators 101 are aligned with reference to the external diameter, the central axes Z of the parallel beams substantially coincide.

However, it is difficult to set the optical axis Z of the parallel beam emitted from the partially spherical lens 102 within a radial range of 0.02 mm centered on the central axis B of the outer circumferential surface of the eccentric sleeve 105, and also within an angle of 0.2° with respect to the central axis B of the outer circumferential surface of the eccentric sleeve 105. Therefore, there is a problem in that the central axes Z of the parallel beams may not coincide in cases where mutually facing optical fiber collimators 101 are aligned with reference to the external diameter.

In contrast, the device shown in FIG. 8 (see the specification of U.S. Pat. No. 5,384,874), for example, has been known as an optical fiber rod lens device which realizes a low insertion loss and high return loss, and which eliminates the eccentricity of the central axis of parallel beam emitted from the lens with respect to the central axis of the lens. FIG. 8 is a diagram showing the basic construction of a conventional optical fiber rod lens device.

The optical fiber rod lens device 201 shown in FIG. 8 comprises an optical fiber 202 consisting of a core 202a and a cladding 202b surrounding the core 202a, and a convergent rod lens 203 connected to the end surface of the optical fiber 202. Furthermore, the optical fiber 202 and rod lens 203 are designed to be connected to each other by fusion such that the central axes of these parts are aligned with each other.

With this optical fiber rod lens device 201, because the optical fiber 202 and rod lens 203 are connected to each other by fusion such that the central axes of these parts are aligned with each other, it is possible to realize a low insertion loss and high return loss and to eliminate the eccentricity of the central axis of parallel beam emitted from the lens with respect to the central axis of the lens.

However, in this optical fiber rod lens device 201, because the optical fiber 202 and rod lens 203 are connected to each other by fusion, the need for a large-scale manufacturing apparatus such as a CO₂ laser and arc discharge apparatus is a problem.

In contrast, the optical connector shown in FIGS. 6A and 6B (see JP-A-5-113519), for example, has been known as an optical connector which realizes a low insertion loss and high return loss, which eliminates the eccentricity of the central axis of parallel beam emitted from the lens with respect to the central axis of the lens, and which does not require any large-scale manufacturing apparatus. FIGS. 6A and 6B show a conventional optical connector; FIG. 9A is a sectional view, and FIG. 9B is an explanatory diagram of the optical connector in a use state.

The optical connector 301 shown in FIG. 9A comprises a connector main body 310, an optical fiber 320, and a spherical lens 330. The connector main body 310 is formed from an opaque resin or the like. The connector main body 310 is provided with a circular conic opening 311 that holds the lens 330, an optical fiber receiving opening 312 that is bored so that its central axis coincides with the central axis of the circular conic opening 311, and alignment openings 313 that are used during mating with a mating optical connector 301 (see FIG. 9B). Furthermore, the optical fiber 320 is inserted into the optical fiber receiving opening 312 from the opposite side of the circular conic opening 311, and is fastened in place by an adhesive. The fastening of the optical fiber 320 is accomplished so that the position of the end of the optical fiber 320 is at the focal point of the optical system that is determined by the diameter and refractive index of the lens 330 and the refractive index of a photocurable resin 340 (described later). Moreover, the silicone buffer 321 and jacket 322 of the optical fiber 320 are also bonded and fastened to the connector main body 310.

Meanwhile, a transparent photocurable resin 340 having substantially the same refractive index as those of the optical fiber 320 and lens 330 is injected into the circular conic opening 311, and the lens 330 is inserted on top of this so that this lens 330 contacts the wall of the circular conic opening 311, thus fastening this lens in place by photocuring of the photocurable resin.

As is shown in FIG. 9B, this optical connector 301 is positioned, abutted, and fastened to the mating connector 301 by the alignment openings 313 and guide pins 314. Furthermore, a beam emitted from the optical fiber 320 of one optical connector 301 passes through the transparent photocurable resin 340, is converted into parallel beams by the lens 330, enters the lens 330 of the other mating optical connector 301, is focused by this lens, further passes through the photocurable resin 340, and is caused to converge at the end surface of the optical fiber 320.

In this optical connector 301, because the optical fiber 320 and lens 330 are fastened by the transparent photocurable resin 340 having substantially the same refractive index as those of the optical fiber 320 and lens 330, a low insertion loss and high return loss can be realized. Moreover, the optical fiber insertion and fiber receiving opening 312 is bored so that the central axis of this fiber receiving opening 312 coincides with the central axis of the circular conic opening 311, and the optical axis of the optical fiber 320 coincides with the central axis of the spherical lens 330; therefore, it is possible to eliminate the eccentricity of the central axis of the parallel beam emitted from the lens 330 with respect to the central axis of the lens 330. In addition, because there is no need to connect the optical fiber 320 and lens 330 by fusion, a large-scale manufacturing apparatus such as an arc discharge apparatus is not required.

However, the following problems have been encountered in this conventional optical connector 301 shown in FIGS. 6A and 6B.

Specifically, the optical fiber 320 is fastened to the connector main body 310 so that the position of the end of the optical fiber 320 is the focal point of the optical system in this optical connector 301. However, there is no mechanism for positioning the optical fiber 320 in the direction of optical axis. Accordingly, when this optical fiber 320 is fastened to the connector main body 310, it is necessary to determine the position of the tip end of the optical fiber 320 while optically monitoring this optical fiber, so that there is a problem in that it is difficult to position the optical fiber in such a manner that the position of the end of the optical fiber 320 is the focal position of the optical system.

Furthermore, the photocurable resin 340 that fastens the lens 330 to the wall of the circular conic opening 311 is injected into the circular conic opening 311 and cured by photocuring after the lens 330 is inserted on top of this resin. Therefore, there is a danger that gas or foreign matter will be mixed in. If gas or foreign matter is mixed into the photocurable resin 340, there is a problem in that beam is scattered when passing though the photocurable resin 340, so that the transmitted beam is attenuated.

Moreover, because the optical fiber 320 is directly inserted into the fiber receiving opening 312, accidents occur in some cases such as breakage of the optical fiber 320 during handling.

### BRIEF SUMMARY

The optical fiber connector of the present invention includes a housing having a ferrule receiving passageway and a lens receiving portion which is disposed on the front end portion of this ferrule receiving passageway. A central axis is coaxial with the central axis of the ferrule receiving passageway. A spherical lens is fastened to the lens receiving portion and a ferrule is inserted into the ferrule receiving passageway from the rear side and is incorporated with an optical fiber whose front end surface is perpendicular to the central axis. A transparent block having a refractive index that is substantially the same as the refractive indices of the lens and optical fiber is disposed between the lens and the ferrule so that this block contacts the lens, the ferrule, and the optical fiber. A refractive index matching agent having a refractive index substantially the same as the refractive indices of the lens and optical fiber is applied around the contact point between the lens and the block and around the contact surface between the ferrule and the block. The thickness of the block in the direction of beam transmission is set to be the same as the distance to the focal point from the end surface of the lens.

### BRIEF DESCRIPTION OF THE DRAWINGS

FIG. 1 is a front view of a first embodiment of the optical connector of the present invention;

FIG. 2 is a perspective view of the optical connector shown in FIG. 1;

FIG. 3 is a partial sectional view along line 3-3 in FIG. 1;

FIG. 4 is a sectional view of a second embodiment of the optical connector of the present invention;

FIG. 5 is a perspective view of a female threaded member;

FIGS. 6A and 6B show a male threaded member, with FIG. 6A being a front view, and FIG. 6B being a side view;

FIG. 7 is a sectional view of a conventional optical fiber collimator;

FIG. 8 is a diagram showing the basic construction of a conventional optical fiber rod lens device; and

FIGS. 9A and 9B show a conventional optical connector, with FIG. 9A being a sectional view, and FIG. 9B being an explanatory diagram of the optical connector in a use state.

### DETAILED DESCRIPTION OF THE EMBODIMENT(S)

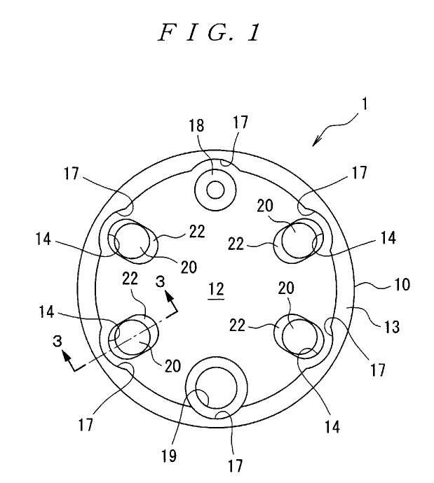

Next, embodiments of the present invention will be described with reference to the figures. In FIGS. 1 through 3, the optical connector 1 comprises a housing 10, a plurality of spherical lenses 20 (four lenses in the present embodiment), and a plurality of ferrules 30 (four ferrules in the present embodiment) that respectively incorporate optical fibers 31.

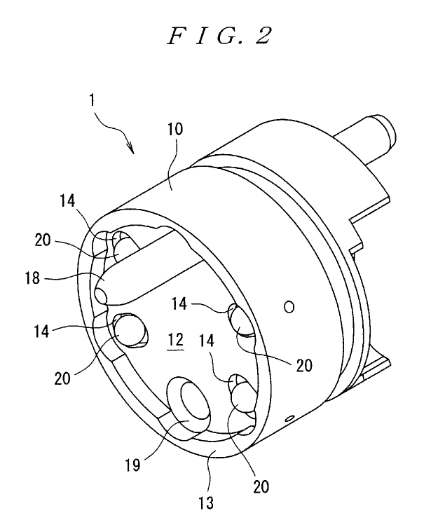

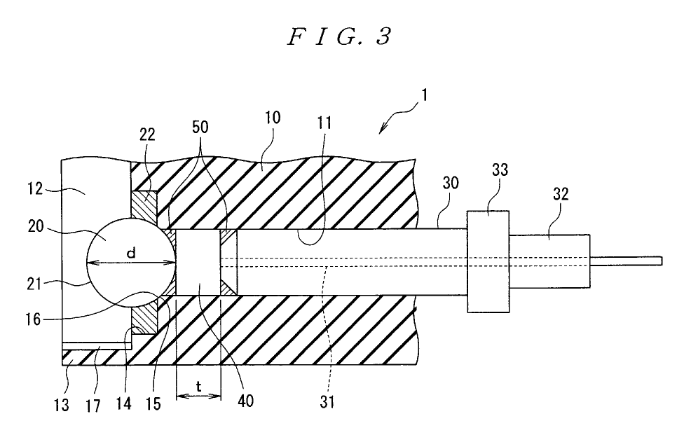

Here, the housing 10 is formed in a cylindrical shape as shown in FIGS. 1 and 2, and a circular recessed section 12 for mating with a mating optical connector (connector having the same shape as the optical connector 1) is formed in the front end portion (left end portion in FIGS. 2 and 3) of this housing. A cylindrical outer wall 13 that surrounds the recessed section 12 is provided on the outside of the recessed section 12. The housing 10 is manufactured from a resin into which a glass filler is mixed, but this housing may also be manufactured from a metal such as stainless steel. Furthermore, a plurality of ferrule receiving passageways 11 (four ferrule receiving passageways in the present embodiment) having a cross-sectional circular shape that extend in the forward-rearward direction (axial direction and left-right direction in FIG. 3) and that pass through the housing 10 are formed in the housing 10. The true alignment of the center of the internal diameter of the housing 10 is 0.05 mm or better. Here, “the true alignment of the center of the internal diameter of the housing 10” refers to the amount of displacement from the center (eccentricity) of the abutting surface (mating surface) of the mating connector. Adhesive injection grooves 14 having a shape that conforms to that of the coating syringe needles (not shown in the figures) are formed in the bottom portion of the recessed section 12 on the front side of the respective ferrule receiving passageways 11. In the present embodiment, the shape of the adhesive injection grooves 14 is the shape of an elongated opening. A lens receiving portion 15 having a central axis that is coaxial with the central axis of each of the ferrule receiving passageways 11 is disposed on the front end portion of the ferrule receiving passageway 11 in the area that intersects with the corresponding adhesive injection groove 14. In other words, the adhesive injection grooves 14 are respectively formed around the lens receiving portions 15. A rounded bevel 16 that conforms to the external shape of each spherical lens 20 is formed in each of these lens receiving portions 15. Thus, because a rounded bevel 16 that conforms to the outer surface of each spherical lens 20 is formed in each lens receiving portion 15, no burr are generated on the lens receiving portions 15, so that the positional deviation of the lenses 20 can be avoided as much as possible. Beveling is not limited to the rounded bevels 16 that conform to the outer surfaces of the lenses 20; 45-degree bevels of 0.05 mm or less may also be respectively formed in the lens receiving portions 15. In this case as well, a similar effect can be obtained. Furthermore, the perpendicularity of the front end surface of the housing 10 including the lens receiving portions 15 (i.e., the bottom surfaces of the adhesive injection grooves 14) with respect to the internal diameter of the housing 10 is 0.005 mm or better, and the circumferential deviation of the lens receiving portions 15 is 0.003 mm or less. Here, “the perpendicularity of the front end surface of the housing 10” including the lens receiving portions 15 with respect to the internal diameter of the housing 10 refers to the inclination with reference to the abutting surface (mating surface) of the mating connector, and is indicated here as the amount of spread. Moreover, “the circumferential deviation of the lens receiving portions 15” refers to the amount of displacement with reference to the true (ideal) central axis (eccentricity) in the respective lens receiving portions.

In addition, as is shown in FIGS. 1 and 2, a positioning pin 18 that is used during the mating with the mating optical connector is provided on the housing 10 so as to protrude from the recessed section 12, and a positioning pin receiving opening 19 that receives the positioning pin provided on the mating optical connector and having the same shape as the positioning pin 18 is formed in the recessed section 12. As is shown in FIG. 1, the positioning pin 18 and positioning pin receiving opening 19 are provided in positions that are rotated 180° on the concentric circle close to the cylindrical outer wall 13. Furthermore, the plurality of ferrule receiving passageways 11 (four ferrule receiving passageways in the present embodiment), lens receiving portions 15, and adhesive injection grooves 14 are provided on the same circle as the positioning pin 18 and positioning pin receiving opening 19 at an equal distance between the positioning pin 18 and positioning pin receiving opening 19. Moreover, as is shown in FIG. 1, cutout recessed parts 17 are formed in the inner circumferential surface of the outer wall 13 and on the outside of the positioning pin 18, on the outside of the positioning pin receiving opening 19, and on the outside of the respective adhesive injection grooves 14. The formation of the cutout recessed parts 17 in the inner circumferential surface of the outer wall 13 and on the outside of the positioning pin 18 and on the outside of the positioning pin receiving opening 19 allows the working of the positioning pin 18 and the working of the positioning pin receiving opening 19 to be facilitated. Furthermore, the formation of the cutout recessed parts 17 in the inner circumferential surface of the outer wall 13 and on the outside of the respective adhesive injection grooves 14 allows the working of the respective adhesive injection grooves 14 and lens receiving portions 15 to be facilitated.

Moreover, the respective lenses 20 are formed in a spherical shape having a diameter d, and are designed to be fastened to the lens receiving portions 15 of the housing 10 by an adhesive 22 injected into the adhesive injection grooves 14. The material of the lenses 20 is BK7, and the refractive index n₂₀ is approximately 1.50. Furthermore, anti-reflective coatings (not shown in the figures) are provided on the side of the front surfaces 21 of the lenses 20 (portions that protrude from the bottom portion of the recessed section 12 of the housing 10).

Furthermore, each of the ferrules 30 is formed in a cylindrical shape, and comprises an optical fiber 31 that is internally incorporated on the same axis. A cap 32 that has a flange 33 having a diameter larger than that of the ferrule 30 is fastened to the rear end portion of each of the ferrules 30. The front end surface of each ferrule 30 is polished so that the front end surface of the ferrule 30 is coplanar with the front end surface of the optical fiber 31. The front end surface of the optical fiber 31 is perpendicular to the central axis of this optical fiber 31. The respective ferrules 30 are designed to be inserted into the ferrule receiving passageways 11 in the housing 10 from the rear side, i.e., on the side opposite from the lenses 20. The internal diameter of the housing 10 corresponding to the internal diameter of these ferrule receiving passageways 11 has a tolerance of 0.003 mm or less with respect to the external diameter of the ferrules 30. Both corner parts on the front end surfaces of the ferrules 30 are beveled. The refractive index n₃₁ of the optical fibers 31 is approximately 1.45.

Moreover, a transparent block 40 is disposed between the lens 20 and ferrule 30 inside each ferrule receiving passageway 11. Here, the term “transparent” means transparent in the wavelength band of beam in which the optical connector 1 is used. Each block 40 is formed in a cylindrical shape which is such that the outer circumferential surface contacts the inner circumferential surface of the ferrule receiving passageway 11, that the front end surface contacts the rear end surface of the lens 20, and that the rear end surface contacts the front end surface of the ferrule 30 and the front end surface of the optical fiber 31. The blocks 40 have a refractive index n₄₀ (=approximately 1.45) substantially equal to the refractive index n₂₀ of the lenses 20 (=approximately 1.50) and the refractive index n₃₁ of the optical fibers 31 (=approximately 1.45). The material of the blocks 40 is quartz glass. Furthermore, the thickness t of the blocks 40 in the direction of beam transmission is set to be the same as the distance to the focal position from the rear end surfaces of the lenses 20 that is determined by the diameter d and refractive index n₂₀ of the lenses 20 and the refractive index n₄₀ of the blocks 40.

In addition, a refractive index matching agent 50 having a refractive index n₅₀ (=approximately 1.45) substantially equal to the refractive index n₂₀ of the lenses 20 (=approximately 1.50) and the refractive index n₃₁ of the optical fibers 31 (=approximately 1.45) is applied around the respective contact points between the lenses 20 and blocks 40 and around the respective contact surfaces between the ferrules 30 and blocks 40. The refractive index matching agent 50 is composed of a universally known material obtained by mixing a glass filler into a silicone-type base material.

Next, a method for manufacturing an optical connector 1 will be described.

First, a plurality of lenses 20 are respectively placed on individual lens receiving portions 15 of the housing 10, and an adhesive 22 is injected into adhesive injection grooves 14, thus fastening the respective lenses 20 to the lens receiving portions 15. In this case, the fastening is accomplished by the adhesive 22, with the anti-reflective coatings on the lenses facing toward the front. As a result, the central axes of the lenses 20 respectively coincide with the central axes of the lens receiving portions 15, and also respectively coincide with the central axes of the ferrule receiving passageways 11. Because the adhesive injection grooves 14 are formed so as to conform to the coating syringe needles, the adhesive 22 can be injected easily.

Next, a refractive index matching agent 50 is applied to the rear surfaces of the respective lenses 20.

Then, blocks 40 are inserted into the respective ferrule receiving passageways 11 from the rear side of the housing 10, and the front end surfaces of the respective blocks 40 are caused to contact the rear end surfaces of the respective lenses 20.

Afterward, a plurality of ferrules 30 and optical fibers 31 having the front end surfaces thereof being coated with the refractive index matching agent 50 are prepared, and these are respectively inserted into the individual ferrule receiving passageways 11 from the rear side of the housing 10. The front end surfaces of the ferrules 30 and optical fibers 31 are caused to contact the rear end surfaces of the blocks 40, and the ferrules 30 are fastened to the housing 10. As a result, an optical connector 1 is completed.

In this optical connector 1, the central axes of the individual lenses 20 respectively coincide with the central axes of the lens receiving portions 15, also respectively coincide with the central axes of the individual ferrule receiving passageways 11, and also respectively coincide with the central axes of the ferrules 30 and optical fibers 31 incorporated in these ferrules 30, and the front end surfaces of the optical fibers 31 are respectively perpendicular to the central axes of these optical fibers 31. Furthermore, the individual ferrules 30 are respectively inserted into the ferrule receiving passageways 11 to a length of half of each ferrule 30 or greater.

The optical connector 1 thus completed mates with a mating optical connector as a result of the positioning pin provided on the mating optical connector being inserted into the positioning pin receiving opening 19, while inserting the positioning pin 18 into the positioning pin receiving opening (not shown in the figures) formed in the mating optical connector. As a result, positioning is performed during the mating with the mating optical connector.

Then, beams emitted from the individual optical fibers 31 of the optical connector 1 respectively pass through the transparent blocks 40, and are emitted after being converted into parallel beams by the respective lenses 20. These parallel beams pass through the respective lenses and blocks of the mating optical connector, and are focused on the tip end surfaces of the respective optical fibers. Furthermore, beams emitted from the individual optical fibers of the mating optical connector respectively pass through transparent blocks, are emitted after being converted into parallel beams by the respective lenses, and are incident on the lenses 20 of the optical connector 1. Then, these incident beams pass through the transparent blocks 40, and are focused on the front end positions of the optical fibers 31.

In this optical connector 1, transparent blocks 40 having a refractive index that is substantially the same as the refractive indices of the lenses 20 and optical fibers 31 are respectively disposed between the lenses 20 and ferrules 30 so that these blocks 40 respectively contact the lenses 20, ferrules 30, and optical fibers 31, and a refractive index matching agent 50 having a refractive index that is substantially the same as the refractive indices of the lenses 20 and optical fibers 31 is applied around the respective contact points between the lenses 20 and blocks 40 and around the respective contact surfaces between the ferrules 30 and blocks 40. Accordingly, the step difference in the refractive index from the optical fibers 31 to the lenses 20 is small, and reflection is small, so that a high return loss can be achieved.

Furthermore, the material of the lenses 20 is BK7, and the blocks 40 are transparent. Therefore, absorption of the transmitted beam is small, so that a low insertion loss can be realized. Moreover, the blocks 40 respectively disposed between the lenses 20 and ferrules 30 (optical fibers 31) are solid, and are not something that is subsequently cured by means of photocuring or the like. Accordingly, there is no danger of gas or foreign matter being admixed during assembly work, so that the risk of attenuation of the transmitted beam due to scattering can be suppressed to the maximum extent possible.

Moreover, the central axes of the lenses 20 respectively coincide with the central axes of the lens receiving portions 15, also respectively coincide with the central axes of the ferrule receiving passageways 11, and also respectively coincide with the central axes of the ferrules 30 and optical fibers 31 incorporated in these ferrules 30, and the front end surfaces of the optical fibers 31 are respectively perpendicular to the central axes of these optical fibers 31. Accordingly, it is possible to eliminate the eccentricity of the central axes of the parallel beams emitted from the lenses 20 with respect to the central axes of the lenses 20. Furthermore, even if the transparent blocks 40 are inclined in a certain range, because the optical step difference is compensated for by filling with the refractive index matching agent 50, there is no generation of eccentricity of the central axes of the parallel beams emitted from the lenses 20 with respect to the central axes of the lenses 20.

Furthermore, because there is no need to connect the lenses 20 and optical fibers 31 by fusion during the manufacture of the optical connector 1, a large-scale manufacturing apparatus such as an arc discharge apparatus is also not required.

Moreover, the thickness t of the blocks 40 in the direction of beam transmission is set to be the same as the distance to the focal position from the rear end surfaces of the lenses 20 that is determined by the diameter d and refractive index n₂₀ of the lenses 20 and the refractive index n₄₀ of the blocks 40. Therefore, positioning can be performed so that the positions of the front ends (tip ends) of the optical fibers 31 are the focal position of the optical system, by fastening the lenses 20 to the lens receiving portions 15 of the housing 10, inserting the blocks 40 into the ferrule receiving passageways 11 so as to contact the lenses 20, and inserting the ferrules 30 into the ferrule receiving passageways 11 to cause the ferrules 30 and optical fibers 31 to contact the blocks 40. Accordingly, the tip end positions of the optical fibers 31 can be positioned easily.

In addition, because the optical fibers 31 are incorporated in the ferrules 30, the risk of breakage of the optical fibers 31 during handling can be greatly reduced.

Furthermore, because anti-reflective coatings are provided on the side of the front surfaces of the lenses 20, the return loss can be further increased.

Moreover, because the material of the blocks 40 is quartz glass, it is possible to obtain a high transmissivity in a wide wavelength range, to make attenuation of beam extremely small, and to suppress the risk of the transmitted beam being attenuated even further. Furthermore, because the processing technology of quartz glass is established, the thickness t of the blocks 40 in the direction of beam transmission can be achieved within an arbitrary tolerance, so that the positioning of the tip end positions of the optical fibers 31 can be performed extremely accurately.

Furthermore, in the optical connector 1, the internal diameter of the housing 10 corresponding to the internal diameter of the ferrule receiving passageways 11 has a tolerance of 0.003 mm or less with respect to the external diameter of the ferrules 30, and the true alignment of the center of the internal diameter of the housing 10 is 0.05 mm or better. Moreover, the perpendicularity of the front end surface of the housing 10 including the lens receiving portions 15 with respect to the internal diameter of the housing 10 is 0.005 mm or better, and the circumferential deviation of the lens receiving portions 15 is 0.003 mm or less. In addition, the ferrules 30 are respectively inserted into the ferrule receiving passageways 11 to a length of half of each ferrule 30 or greater. Because of these facts, the position and direction of the central axis of parallel beam emitted from the lenses 20 can be determined precisely with respect to the front surface of the optical connector, which is the reference surface of the optical connector 1. Therefore, when a pair of optical connectors 1 are used facing each other, the adjustment of the central axis of the parallel beam can be accomplished by the abutting of the front surfaces of the optical connectors. Specifically, the adjustment of the central axis of the parallel beam in the rotational direction is performed by the positioning pin 18 on the front surface of the optical connector and the positioning pin receiving opening formed in the mating optical connector that receives this positioning pin 18 and also by the positioning pin on the front surface of the mating connector and the positioning pin receiving opening 19 in the front surface of the optical connector that receives this positioning pin. Furthermore, the adjustment of the angle of the parallel beam is performed by the abutting of the front surfaces of the optical connectors, i.e., alignment is performed using the abutting surface (mating surface) with the mating connector as a reference surface.

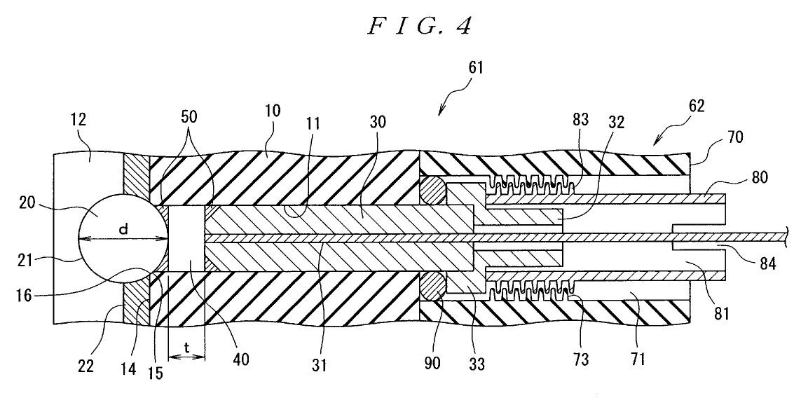

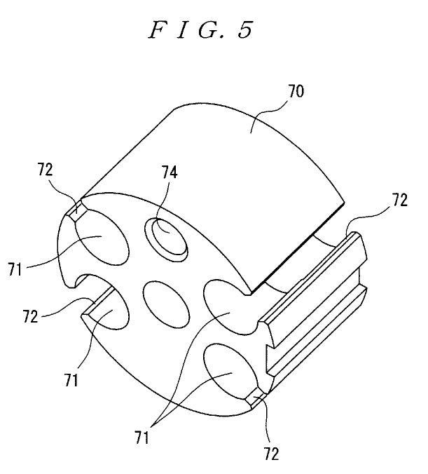

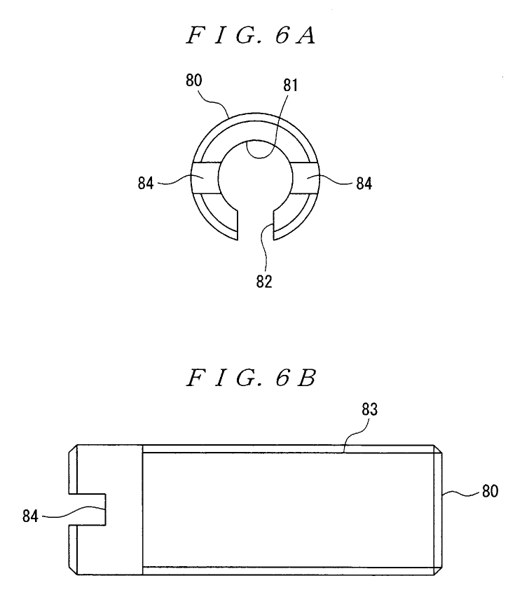

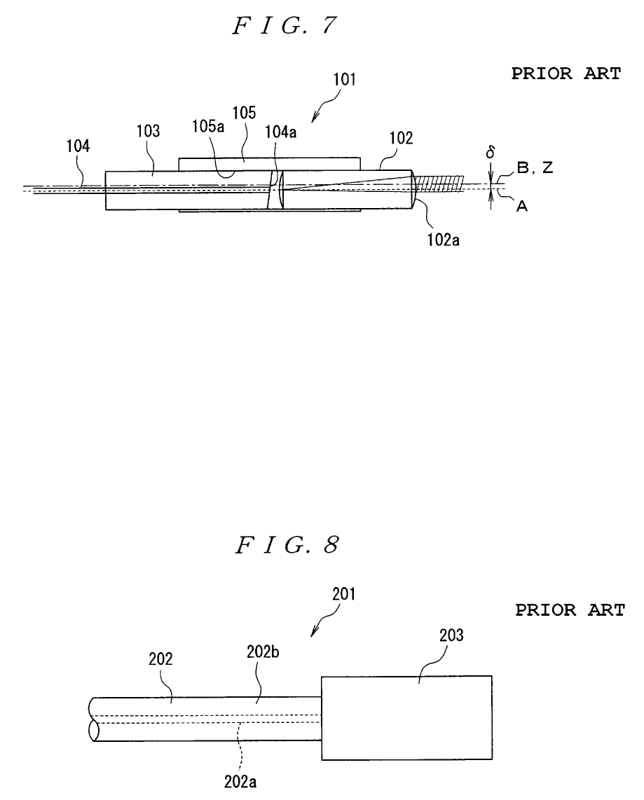

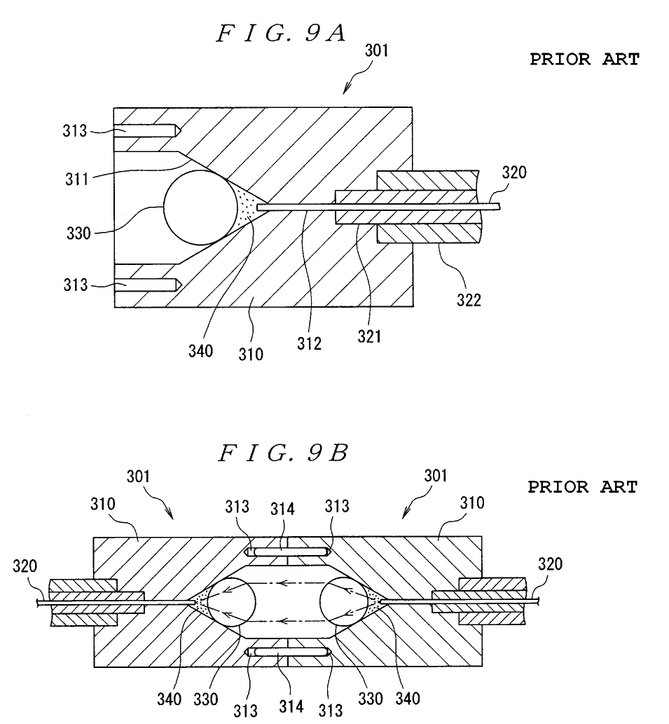

Next, a second embodiment of the optical connector of the present invention will be described with reference to FIGS. 4, 5, 6A and 6B. FIG. 4 is a sectional view of a second embodiment of the optical connector of the present invention. FIG. 5 is a perspective view of a female threaded member. FIGS. 6A and 6B show a male threaded member; FIG. 6A is a front view, and FIG. 6B is a side view.

In FIG. 4, as in the case with the optical connector 1 shown in FIGS. 1 through 3, the optical connector 61 comprises a housing 10, a plurality of spherical lenses 20 (four lenses in the present embodiment), and a plurality of ferrules 30 (four ferrules in the present embodiment) that respectively incorporate optical fibers 31.

Here, as in the case with the housing 10 shown in FIGS. 1 through 3, the housing 10 is formed in a cylindrical shape, and a circular recessed section 12 for mating with a mating optical connector (connector having the same shape as the optical connector 61) is formed in the front end portion (left end portion in FIG. 4) of the housing. A cylindrical outer wall (not shown in the figures) that surrounds the recessed section 12 is provided on the outside of the recessed section 12. The housing 10 is manufactured from a resin into which glass fibers are mixed, but this housing may also be manufactured from a metal such as stainless steel. Furthermore, a plurality of ferrule receiving passageways 11 (four ferrule receiving passageways in the present embodiment) having a cross-sectional circular shape that extend in the forward-rearward direction (axial direction and left-right direction in FIG. 4) and that pass through the housing 10 are formed in the housing 10. The true alignment of the center of the internal diameter of the housing 10 is 0.05 mm or better. Here, “the true alignment of the center of the internal diameter of the housing 10” refers to the amount of displacement from the center (eccentricity) of the abutting surface (mating surface) of the mating connector. Adhesive injection grooves 14 having a shape that conforms to that of the coating syringe needles are formed in the bottom portion of the recessed section 12 on the front side of the respective ferrule receiving passageways 11. In the present embodiment, the adhesive injection grooves 14 have the shape of an elongated opening. A lens receiving portion 15 having a central axis that is coaxial with the central axis of each of the ferrule receiving passageways 11 is disposed on the front end portion of the ferrule receiving passageway 11 in the area that intersects with the corresponding adhesive injection groove 14. In other words, the adhesive injection grooves 14 are respectively formed around the lens receiving portions 15. A rounded bevel 16 that conforms to the external shape of each spherical lens 20 is formed in each of these lens receiving portions 15. Thus, because a rounded bevel 16 that conforms to the outer surface of each spherical lens 20 is formed in each lens receiving portion 15, no “burr” is generated on the lens receiving portions 15, so that the positional deviation of the lenses 20 can be avoided as much as possible. Beveling is not limited to the rounded bevels 16 that conform to the outer surfaces of the lenses 20; for example, 45-degree bevels of 0.05 mm or less may also be respectively formed in the lens receiving portions 15. In this case as well, a similar effect can be obtained. Furthermore, the perpendicularity of the front end surface of the housing 10 including the lens receiving portions 15 (i.e., the bottom surfaces of the adhesive injection grooves 14) with respect to the internal diameter of the housing 10 is 0.005 mm or better, and the circumferential deviation of the lens receiving portions 15 is 0.003 mm or less. Here, “the perpendicularity of the front end surface of the housing 10 including the lens receiving portions 15 with respect to the internal diameter of the housing 10” refers to the inclination with reference to the abutting surface (mating surface) of the mating connector, and is indicated here as the amount of spread. Moreover, “the circumferential deviation of the lens receiving portions 15” refers to the amount of displacement with reference to the true (ideal) central axis (eccentricity) in the respective lens receiving portions.

Furthermore, although this is not shown in the figures, as in the housing 10 shown in FIGS. 1 through 3, a positioning pin that is used during the mating with the mating optical connector is provided on this housing 10 so as to protrude from the recessed section 12, and a positioning pin receiving opening that receives the positioning pin provided on the mating optical connector is formed in the recessed section 12. Furthermore, the arrangement of the positioning pin, positioning pin receiving opening, ferrule receiving passageways 11, lens receiving portions 15, and adhesive injection grooves 14 in the circumferential direction is the same as in the optical connector 1 shown in FIGS. 1 through 3.

Moreover, as in the lenses 20 shown in FIGS. 1 through 3, the respective lenses 20 are formed in a spherical shape having a diameter d, and are designed to be fastened to the lens receiving portions 15 of the housing 10 by an adhesive 22 injected into the adhesive injection grooves 14. The material of the lenses 20 is BK7, and the refractive index n₂₀ is approximately 1.50. Furthermore, anti-reflective coatings (not shown in the figures) are provided on the side of the front surfaces 21 of the lenses 20 (portions that protrude from the bottom portion of the recessed section 12 of the housing 10).

Furthermore, as in the ferrules 30 shown in FIG. 3, each of the ferrules 30 is formed in a cylindrical shape, and comprises an optical fiber 31 that is internally incorporated on the same axis. A cap 32 that has a flange 33 having a diameter larger than that of the ferrule 30 is press-fitted to the rear end portion of each of the ferrules 30. The front end surface of each ferrule 30 is polished so that the front end surface of the ferrule 30 is coplanar with the front end surface of the optical fiber 31. The front end surface of the optical fiber 31 is perpendicular to the central axis of this optical fiber 31. The respective ferrules 30 are designed to be inserted into the ferrule receiving passageways 11 in the housing 10 from the rear side, i.e., on the side opposite from the lenses 20. The internal diameter of the housing 10 corresponding to the internal diameter of these ferrule receiving passageways 11 has a tolerance of 0.003 mm or less with respect to the external diameter of the ferrules 30. Both corner parts on the front end surfaces of the ferrules 30 are beveled. The refractive index n₃₁ of the optical fibers 31 is approximately 1.45.

Moreover, as in the optical connector 1 shown in FIG. 3, a transparent block 40 is disposed between the lens 20 and ferrule 30 inside each ferrule receiving passageway 11. Here, the term “transparent” means transparent in the wavelength band of beam in which the optical connector 1 is used. Each block 40 is formed in a cylindrical shape which is such that the outer circumferential surface contacts the inner circumferential surface of the ferrule receiving passageway 11, that the front end surface contacts the rear end surface of the lens 20, and that the rear end surface contacts the front end surface of the ferrule 30 and the front end surface of the optical fiber 31. The blocks 40 have a refractive index n₄₀ (=approximately 1.45) substantially equal to the refractive index n₂₀ of the lenses 20 (=approximately 1.50) and the refractive index n₃₁ of the optical fibers 31 (=approximately 1.45). The material of the blocks 40 is quartz glass. Furthermore, the thickness t of the blocks 40 in the direction of beam transmission is set to be the same as the distance to the focal position from the rear end surfaces of the lenses 20 that is determined by the diameter d and refractive index n₂₀ of the lenses 20 and the refractive index n₄₀ of the blocks 40.

In addition, as in the optical connector 1 shown in FIG. 3, a refractive index matching agent 50 having a refractive index n₅₀ (=approximately 1.45) substantially equal to the refractive index n₂₀ of the lenses 20 (=approximately 1.50) and the refractive index n₃₁ of the optical fibers 31 (=approximately 1.45) is applied around the respective contact points between the lenses 20 and blocks 40 and around the respective contact surfaces between the ferrules 30 and blocks 40. The refractive index matching agent 50 is composed of a universally known material obtained by mixing a glass filler into a silicone-type base material.

Furthermore, unlike the optical connector 1 shown in FIGS. 1 through 3, the optical connector 61 comprises a ferrule fastener 62 for fastening the ferrules 30 to the housing 10. This ferrule fastener 62 is constructed from a female threaded member 70, a plurality of male threaded members 80 (four male threaded members in the present embodiment), and a plurality of elastomeric members 90 (four elastic bodies in the present embodiment).

The female threaded member 70 is formed in a substantially cylindrical shape, and is disposed on and fastened to the rear end surface of the housing 10. The female threaded member 70 is provided with a plurality of ferrule through-openings 71 (four ferrule through-openings in the present embodiment) that extend in the forward-rearward direction and that allow the insertion of the ferrules 30 and caps 32 fastened to the rear end portions of the ferrules 30. A threaded section 73 is provided on the inner circumferential surface of each of the ferrule through-openings 71. Moreover, as is shown in FIG. 5, slots 72 that extend in the forward-rearward direction and that allow the optical fibers 31 to be inserted into the respective ferrule through-openings 71 from the outside of the female threaded member 70 are respectively formed in the outside surfaces of the individual ferrule through-openings 71 of the female threaded member 70. Furthermore, a through-opening 74 which extends in the forward-rearward direction, and into which a positioning pin (not shown in the figures) is inserted is formed in the female threaded member 70 as shown in FIG. 5.

In addition, the respective male threaded members 80 are formed in a hollow cylindrical shape that allows the insertion into the respective ferrule through-openings 71 of the female threaded member 70. Each male threaded member 80 is provided with a through-opening 81 that passes through in the forward-rearward direction so as to receive the rear end portion of the cap 32 of one of the ferrules 30 and so as to lead out the corresponding optical fiber toward the rear. Male threaded sections 83 that are screwed into the female threaded sections 73 provided on the respective ferrule through-openings 71 are provided on the outer circumferential surfaces of the respective male threaded members 80. The respective male threaded members 80 are designed to work as follows: namely, as a result of the male threaded members 80 being inserted into the respective ferrule through-openings 71 from the rear of the female threaded member 70 and rotated, the male threaded sections 83 are respectively screwed into the female threaded sections 73, and when the rotation is continued, the front ends of the respective male threaded members 80 contact the rear end surfaces of the flanges 33 of the caps 32 and press the ferrules 30 in the forward direction. As is shown in FIGS. 6A and 6B, a groove 84 into which the end of a tool such as a driver for rotating the male threaded members 80 is inserted is formed in the rear end portion of each male threaded member 80. Furthermore, a slot 82 that extends in the forward-rearward direction is formed in the side surface of each male threaded member 80 as shown in FIG. 6A, and these slots 82 allow the optical fibers 31 to be inserted into the through-openings 81 from the outside of the male threaded members 80.

Moreover, an elastomeric member 90 is disposed inside each ferrule through-opening 71 of the female threaded member 70 between the rear end surface of the housing 10 and the front end surface of the flange 33 of the cap 32. When the individual male threaded members 80 respectively contact the rear end surfaces of the flanges 33 of the caps 32 and press the ferrules 30 in the forward direction, these elastomeric members 90 are designed to apply an elastic force that presses the ferrules 30 in the rearward direction inside the elastic regions via the caps 32 fastened to the ferrules 30. Because a construction is used in which the caps 32 respectively press the ferrules 30 forward via the elastomeric members 90, the ferrules 30 are not subjected to any direct pressing force from the caps 32, and the ferrules 30 can also be held without any rattling between the ferrules 30 and blocks 40 and between the blocks 40 and lenses 20. These elastomeric members 90 are constructed from rubber, but may also be constructed from a metal (e.g., washer or spring member) or a composite of a metal and rubber.

Next, a method for manufacturing an optical connector 61 will be described.

First, a plurality of lenses 20 are respectively placed on individual lens receiving portions 15 of the housing 10, and an adhesive 22 is injected into adhesive injection grooves 14, thus fastening the respective lenses 20 to the lens receiving portions 15. In this case, the fastening is accomplished by the adhesive 22, with the anti-reflective coatings on the lenses facing toward the front. As a result, the central axes of the lenses 20 respectively coincide with the central axes of the lens receiving portions 15, and also respectively coincide with the central axes of the ferrule receiving passageways 11. Because the adhesive injection grooves 14 are formed so as to conform to the coating syringe needles, the adhesive 22 can be injected easily.

Next, a refractive index matching agent 50 is applied to the rear surfaces of the respective lenses 20.

Then, blocks 40 are inserted into the respective ferrule receiving passageways 11 from the rear side of the housing 10, and the front end surfaces of the respective blocks 40 are caused to contact the rear end surfaces of the respective lenses 20.

Afterward, a plurality of ferrules 30 and optical fibers 31 having the front end surfaces thereof being coated with the refractive index matching agent 50 are prepared, and these are respectively inserted into the individual ferrule receiving passageways 11 from the rear side of the housing 10. The front end surfaces of the ferrules 30 and optical fibers 31 contact the rear end surfaces of the blocks 40.

Next, elastomeric members 90 are respectively disposed between the rear end surface of the housing and the front end surfaces of the flanges 33 of the caps 32 fastened to the individual ferrules 30.

Then, a female threaded member 70 is fastened to the rear end surface of the housing 10 by inserting the ferrules 30, cap 32, and elastomeric members 90 into the respective through-openings 71. In this case, the optical fibers 31 can be inserted easily into the respective through-openings 71 from the outside of the female threaded member 70 by being passed through the slots 72.

Subsequently, individual male threaded members 80 are respectively inserted into the ferrule through-openings 71 from the rear side of the female threaded member 70 and rotated, thus screwing the male threaded sections 83 to the female threaded sections 73. Then, by continuing the rotation of the respective male threaded members 80, the front ends of the respective male threaded members 80 are caused to contact the rear end surfaces of the flanges 33 of the caps 32, and the male threaded members 80 are further inserted by continuing the rotation further, so that the ferrules 30 are pressed in the forward direction. Here, the amount of the insertion of the male threaded members 80 is adjusted so that the front end surfaces of the flanges 33 are located in arbitrary positions in the elastic regions of the elastomeric members 90, thus adjusting the front end positions of the ferrules 30. This causes the elastomeric members 90 to exert an elastic force that presses the ferrules 30 in the rearward direction via the caps 32 fastened to the ferrules 30. As a result, the ferrules 30 are fastened to the housing 10, and an optical connector 61 is completed. Furthermore, the work of rotating the male threaded members 80 is accomplished by inserting the end of a tool such as a screw driver into each of the grooves 84. Moreover, the optical fibers 31 can be inserted easily into the through-openings 81 from the outside of the male threaded members 80 by being passed through the slots 82.

In this optical connector 61, the central axes of the individual lenses 20 respectively coincide with the central axes of the lens receiving portions 15, also respectively coincide with the central axes of the individual ferrule receiving passageways 11, and also respectively coincide with the central axes of the ferrules 30 and optical fibers 31 incorporated in these ferrules 30, and the front end surfaces of the optical fibers 31 are respectively perpendicular to the central axes of these optical fibers 31. Furthermore, the individual ferrules 30 are respectively inserted into the ferrule receiving passageways 11 to a length of half of each ferrule 30 or greater.

Here, because the elastomeric members 90 apply an elastic force that presses the ferrules 30 rearward via the caps 32, the pressing force of the ferrules 30 on the blocks 40 and the pressing force on the lenses 20 are very small, so that there is no generation of positional deviation in the respective contact points between the front end surfaces of the ferrules 30 and the rear end surfaces of the blocks 40 and in the respective contact points between the front end surfaces of the blocks 40 and the rear end surfaces of the lenses 20. Therefore, there is no positional deviation between the central axes of the respective lenses 20 and the central axes of the ferrules 30 and optical fibers 31 incorporated in these ferrules 30. Furthermore, because the pressing force on the lenses 20 is very small, there is no danger of the lenses 20 being damaged. Because a construction is used in which the caps 32 press the ferrules 30 forward via the elastomeric members 90, the ferrules 30 do not directly receive any pressing force from the caps 32. Moreover, the ferrules 30 can be held without any rattling between the ferrules 30 and blocks 40 and between the blocks 40 and lenses 20.

The optical connector 61 thus completed mates with a mating optical connector as a result of the positioning pin provided on the mating optical connector being inserted into the positioning pin receiving opening, while inserting the positioning pin (not shown in the figures) into the positioning pin receiving opening (not shown in the figures) formed in the mating optical connector. Accordingly, positioning is accomplished during the mating with the mating optical connector.

Then, beams emitted from the individual optical fibers 31 of the optical connector 61 respectively pass through the transparent blocks 40, and are emitted after being converted into parallel beams by the respective lenses 20. These parallel beams pass through the respective lenses and blocks of the mating optical connector, and are focused on the end surfaces of the respective optical fibers. Furthermore, beams emitted from the individual optical fibers of the mating optical connector respectively pass through transparent blocks, are emitted after being converted into parallel beams by the respective lenses, and are incident on the lenses 20 of the optical connector 61. Then, these incident beams pass through the transparent blocks 40, and are focused on the front end positions of the optical fibers 31.

In this optical connector 61, as in the optical connector 1, transparent blocks 40 having a refractive index that is substantially the same as the refractive indices of the lenses 20 and optical fibers 31 are respectively disposed between the lenses 20 and ferrules 30 so that these blocks 40 respectively contact the lenses 20, ferrules 30, and optical fibers 31, and a refractive index matching agent 50 having a refractive index that is substantially the same as the refractive indices of the lenses 20 and optical fibers 31 is applied around the respective contact points between the lenses 20 and blocks 40 and around the respective contact surfaces between the ferrules 30 and blocks 40. Accordingly, the step difference in the refractive index from the optical fibers 31 to the lenses 20 is small, and reflection is small, so that a high return loss can be achieved.

Furthermore, the material of the lenses 20 is BK7, and the blocks 40 are transparent. Therefore, absorption of the transmitted beam is small, so that a low insertion loss can be realized. Moreover, the blocks 40 respectively disposed between the lenses 20 and ferrules 30 (optical fibers 31) are solid, and are not something that is subsequently cured by means of photocuring or the like. Accordingly, there is no danger of gas or foreign matter being admixed during assembly work, so that the risk of attenuation of the transmitted beam due to scattering can be suppressed to the maximum extent possible.

Moreover, the central axes of the lenses 20 respectively coincide with the central axes of the lens receiving portions 15, also respectively coincide with the central axes of the ferrule receiving passageways 11, and also respectively coincide with the central axes of the ferrules 30 and optical fibers 31 incorporated in these ferrules 30, and the front end surfaces of the optical fibers 31 are respectively perpendicular to the central axes of these optical fibers 31. Accordingly, it is possible to eliminate the eccentricity of the central axes of the parallel beams emitted from the lenses 20 with respect to the central axes of the lenses 20. Furthermore, even if the transparent blocks 40 are inclined in a certain range, because the optical step difference is compensated for by filling with the refractive index matching agent 50, there is no generation of eccentricity of the central axes of the parallel beams emitted from the lenses 20 with respect to the central axes of the lenses 20.

Furthermore, because there is no need to connect the lenses 20 and optical fibers 31 by fusion during the manufacture of the optical connector 61, a large-scale manufacturing apparatus such as an arc discharge apparatus is also not required.

Moreover, the thickness t of the blocks 40 in the direction of beam transmission is set to be the same as the distance to the focal position from the rear end surfaces of the lenses 20 that is determined by the diameter d and refractive index n₂₀ of the lenses 20 and the refractive index n₄₀ of the blocks 40. Therefore, positioning can be performed so that the positions of the front ends (tip ends) of the optical fibers 31 are the focal position of the optical system, by fastening the lenses 20 to the lens receiving portions 15 of the housing 10, inserting the blocks 40 into the ferrule receiving passageways 11 so as to contact the lenses 20, and inserting the ferrules 30 into the ferrule receiving passageways 11 to cause the ferrules 30 and optical fibers 31 to contact the blocks 40. Accordingly, the tip end positions of the optical fibers 31 can be positioned easily.

In addition, because the optical fibers 31 are incorporated in the ferrules 30, the risk of breakage of the optical fibers 31 during handling can be greatly reduced.

Furthermore, because anti-reflective coatings are provided on the side of the front surfaces of the lenses 20, the return loss can be further increased.

Moreover, because the material of the blocks 40 is quartz glass, it is possible to obtain a high transmissivity in a wide wavelength range, to make attenuation of beam extremely small, and to suppress the risk of the transmitted beam being attenuated even further. Furthermore, because the processing technology of quartz glass is established, the thickness of the blocks in the direction of beam transmission can be achieved within an arbitrary tolerance, so that the positioning of the tip end positions of the optical fibers 31 can be performed extremely accurately.

Furthermore, in the optical connector 61 as well, the internal diameter of the housing 10 corresponding to the internal diameter of the ferrule receiving passageways 11 has a tolerance of 0.003 mm or less with respect to the external diameter of the ferrules 30, and the true alignment of the center of the internal diameter of the housing 10 is 0.05 mm or better. Moreover, the perpendicularity of the front end surface of the housing 10 including the lens receiving portions 15 with respect to the internal diameter of the housing 10 is 0.005 mm or better, and the circumferential deviation of the lens receiving portions 15 is 0.003 mm or less. In addition, the ferrules 30 are respectively inserted into the ferrule receiving passageways 11 to a length of half of each ferrule 30 or greater. Because of these facts, the position and direction of the central axis of parallel beam emitted from the lenses 20 can be determined precisely with respect to the front surface of the optical connector, which is the reference surface of the optical connector 61. Therefore, when a pair of optical connectors 61 are used facing each other, the adjustment of the central axis of the parallel beam can be accomplished by the abutting of the front surfaces of the optical connectors. Specifically, the adjustment of the central axis of the parallel beam in the rotational direction is performed by the positioning pin on the front surface of the optical connector and the positioning pin receiving opening formed in the mating optical connector that receives this positioning pin and also by the positioning pin on the front surface of the mating connector and the positioning pin receiving opening in the front surface of the optical connector that receives this positioning pin. Furthermore, the adjustment of the angle of the parallel beam is performed by the abutting of the front surfaces of the optical connectors, i.e., alignment is performed using the abutting surface (mating surface) with the mating connector as a reference surface.

Embodiments of the present invention have been described above. However, the present invention is not limited to these embodiments, and various alterations and modifications can be made.

For example, the material of the lenses 20 is not limited to BK7, the material of the blocks 40 is not limited to quartz glass, and the material of the refractive index matching agent 50 is not limited to a material obtained by mixing glass fibers into a silicone-type base material.

Furthermore, it is sufficient as long as the positioning pin receiving opening 19 formed in the housing 10 receives a positioning pin provided on a mating optical connector; it is not absolutely necessary to receive a positioning pin having the same shape as the positioning pin 18 provided on the housing 10.

What is claimed is:

1. An optical connector comprising:
a housing comprising a ferrule receiving passageway which extends and passes therethrough, and a lens receiving portion which is disposed on the front end portion of the ferrule receiving passageway, and which has a central axis that is coaxial with the central axis of the ferrule receiving passageway;
a spherical lens fastened to the lens receiving portion; and
a ferrule inserted into the ferrule receiving passageway from the rear side and incorporated with an optical fiber whose front end surface is perpendicular to the central axis, wherein
a transparent block having a refractive index that is substantially the same as refractive indices of the lens and optical fiber is disposed between the lens and the ferrule so that the block contacts the lens, the ferrule, and the optical fiber,
a refractive index matching agent having a refractive index that is substantially the same as the refractive indices of the lens and optical fiber is applied around the contact point between the lens and the block and around the contact surface between the ferrule and the block, and
the thickness of the block in the direction of beam transmission is set to be the same as the distance to the focal point from the end surface of the lens.

2. The optical connector according to claim 1, wherein an anti-reflective coating is provided on the side of the front surface of the lens.

3. The optical connector according to claim 1, wherein the material of the block is quartz glass.

4. The optical connector according to claim 1, wherein the internal diameter of the housing corresponding to the internal diameter of the ferrule receiving passageway has a tolerance of 0.003 mm or less with respect to the external diameter of the ferrule, the true alignment of the center of the internal diameter of the housing is 0.05 mm or better, the perpendicularity of the front end surface of the housing including the lens receiving portion with respect to the internal diameter of the housing is 0.005 mm or better, the circumferential deviation of the lens receiving portion is 0.003 mm or less, and the ferrule is inserted into the ferrule receiving passageway to a length of half of the ferrule or greater.

5. The optical connector according to claim 1, wherein a rounded bevel that conforms to the outer surface of the lens or a 45-degree bevel of 0.05 mm or less is formed in the lens receiving portion of the housing.

6. The optical connector according to claim 1, wherein a positioning pin that is used during the mating with a mating optical connector is provided on the housing, and a positioning pin receiving opening that receives the positioning pin provided on the mating optical connector is formed in the housing.

7. The optical connector according to claim 1, wherein an adhesive injection groove is formed around the lens receiving portion.

8. The optical connector according to claim 1, comprising:
a female threaded member which is fastened to a rear end surface of the housing, and which has a ferrule through-opening that passes therethrough and that allows the insertion of the ferrule, the ferrule through-opening having a female threaded section formed on the inner circumferential surface thereof.

9. The optical connector according to claim 8, comprising:
a male threaded member which is inserted into the ferrule through-opening of the female threaded member, which has on the outer circumferential surface a male threaded section that is screwed into the female threaded section, which has a through-opening that passes therethrough and that allows the optical fiber extending from the ferrule to be led out to the rear, and which presses the ferrule in the forward direction.

10. The optical connector according to claim 9, comprising:
a ferrule fastener having an elastomeric member which is disposed inside the ferrule through-opening in the female threaded member, and which applies an elastic force that presses the ferrule in the rearward direction when the male threaded member presses the ferrule in the forward direction.

11. The optical connector according to claim 10, wherein a slot formed in the outside surface of the ferrule through-opening in the female threaded member allows the optical fiber to be inserted into the ferrule through-opening from the outside of the female threaded member.

12. The optical connector according to claim 10, wherein a slot is formed in the side surface of the male threaded member that allows the optical fiber to be inserted into the through-opening from the outside of the male threaded member.
